(19) United States
(12) Patent Application Publication
(10) Pub. No.: US 2023/0330705 A1
(43) Pub. Date: Oct. 19, 2023

(54) Rotary Sonotrode

(71) Applicant: MS Ultraschall Technologie GmbH, Spaichingen (DE)

(72) Inventors: Thomas WINKER, Balgheim (DE); Fabian KELLER, Tuttlingen (DE); Volker KRELL, Neuhausen ob Eck (DE)

(21) Appl. No.: 18/126,719

(22) Filed: Mar. 27, 2023

(30) Foreign Application Priority Data
Apr. 14, 2022 (DE) 102022109304.2

(51) Int. Cl. B06B 3/00; B06B 1/10

(52) U.S. Cl. CPC B06B 3/00; B06B 1/10

(57) ABSTRACT

A rotary sonotrode comprises a rotary body that has a working surface and that is rotatably supported about its longitudinal axis in at least one rotary bearing. A vibration damper is provided between the rotary bearing and the rotary body.

The present invention relates to a rotary sonotrode comprising a rotary body that has a working surface and that is rotatably supported about its longitudinal axis in at least one rotary bearing.

Such rotary sonotrodes are known from the prior art and serve to process areal material by means of ultrasound. Here, the rotary sonotrode is rotated about its longitudinal axis by a drive, while ultrasonic vibrations are generated in the rotary body at the same time with the aid of a converter so that energy can be transmitted to a workpiece in the region of the working surface in order to emboss, to seal, to weld and/or to cut the workpiece.

The rotary bearings of such rotary sonotrodes are usually arranged in the region of the vibration nodes of the rotary sonotrode, wherein embodiments are known from the prior art in which bearing rings of the rotary body are formed in one piece with the rotary body.

However, in the event of a great pressure load on the working surface, it may be necessary to bring the bearing points, and thus also the vibration nodes, as close as possible to the working surface, which makes a single-piece formation of the rotary body and the bearing seat more difficult.

Against this background, it is the object of the invention to further develop a rotary sonotrode in accordance with the preamble of claim 1 such that a heating of the bearing points in the region of the rotary body as well as a no-load power of the sonotrode are minimized.

This object is satisfied by the features of claim 1 and in particular in that a vibration damper is provided between the rotary bearing and the rotary body and has an inner ring and an outer ring, wherein the inner ring and the outer ring are connected to one another in one piece via spokes. Furthermore, the inner ring is connected to the rotary body in a rotationally fixed manner but not in one piece and the outer ring of the vibration damper is rotatably received in the rotary bearing.

In the rotary sonotrode in accordance with the invention, a transmission of ultrasonic vibrations from the rotary body to the rotary bearing is greatly reduced since the vibration damper ensures, through an elastic deformation of the spokes, that vibrations of the rotary body are practically no longer transmitted to the rotary bearing. Since the vibration damper, with its inner ring, is connected to the rotary body in a rotationally fixed manner but not in one piece, the vibration damper can be manufactured separately from the rotary body and can then be fastened to the rotary body very close to the working surface thereof. In this respect, the rotary body in a manner known per se has a disk-like element, whose outer jacket surface forms the working surface, and a shaft-like section that extends at both sides of the working surface in the axial direction and that is formed in one piece with the disk-like element.

Advantageous embodiments of the invention are described in the description, in the drawing, and in the dependent claims.

In accordance with a first advantageous embodiment, the spokes can extend in a radial direction from the inner ring to the outer ring. In this embodiment, the spokes generally extend along a radial beam that extends through the axis of rotation of the vibration damper.

In accordance with a further advantageous embodiment, the spokes can also extend spirally from the inner ring to the outer ring. With this embodiment, it was possible to achieve good results in a first test.

In accordance with a further advantageous embodiment, the spokes can taper in the radial direction from the inner ring to the outer ring so that a spoke appears conical or trapezoidal in a plan view.

In accordance with a further advantageous embodiment, the spokes can also widen in the radial direction from the inner ring to the outer ring.

In accordance with a further advantageous embodiment, the spokes form an outer side of the vibration damper, i.e. the spokes are not arranged completely within the inner ring and within the outer ring, viewed in the axial direction. Rather, the vibration damper can be placed on a planar surface such that all the spokes contact the surface.

In accordance with a further advantageous embodiment, the inner ring can be provided with a circular groove, which has a positive effect on the vibration damping.

In accordance with a further advantageous embodiment, the vibration damper can be manufactured in one piece and can in particular be manufactured from metal, for example, by milling, eroding, casting or by manufacturing in 3D printing.

In accordance with a further advantageous embodiment, the rotary sonotrode can have a converter that is electrically and mechanically connected to a contactless rotary coupler, wherein the rotary sonotrode has a single axial bearing that is arranged in a region that extends in an axial direction from the rotary coupler up to the converter. In this embodiment, the at least one rotary bearing in which the vibration damper is received is a pure radial bearing, for example, a cylinder roller bearing or a needle bearing. In this embodiment, an axial support is provided exclusively in the vicinity of the rotary coupler since a precise axial support is required there to keep an air gap constant within the rotary coupler. The actual support of the rotary sonotrode at one or both sides of the working surface can then be achieved with pure radial bearings since a slight axial displacement of the working surface due to temperature changes is not critical at this point.

In accordance with a further advantageous embodiment, the rotary sonotrode can have a respective vibration damper at both sides of the working surface, the outer ring of said vibration damper being rotatably received in a respective rotary bearing.

In accordance with a further aspect, the present invention relates to a vibration damper of the kind described above for a rotary sonotrode, wherein the vibration damper has an inner ring and an outer ring, and wherein the inner ring and the outer ring are connected to one another in one piece via spokes. The spokes or the vibration damper can be configured as described above. The vibration damper can in particular have an inner ring that has a circular groove at the base of the spokes.

The present invention will be described in the following purely by way of example with reference to advantageous embodiments and to the enclosed drawings. There are shown:

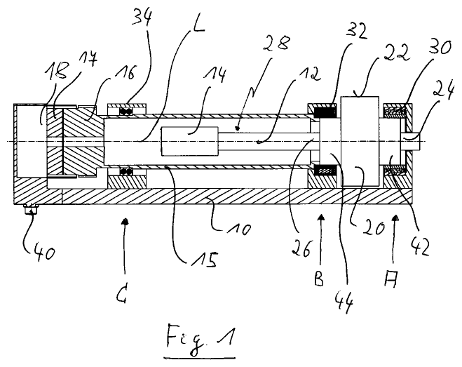

FIG. 1 a longitudinal section through a rotary sonotrode;

FIG. 2 a longitudinal section through the rotary body of the rotary sonotrode of FIG. 1;

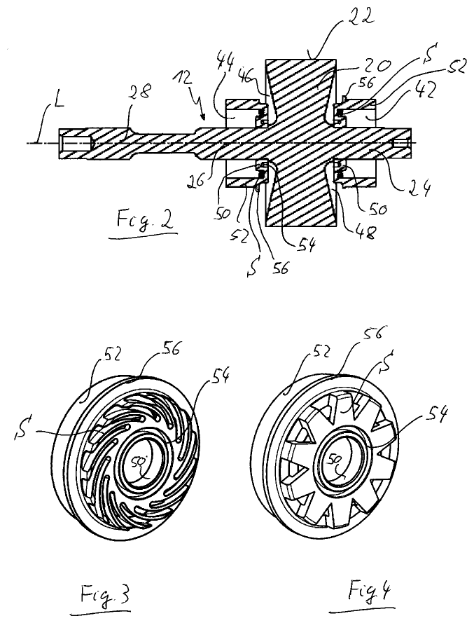

FIG. 3 an embodiment of a vibration damper with spiral spokes; and

FIG. 4 an embodiment of a vibration damper with radial spokes.

FIG. 1 shows an exemplary embodiment of a rotary sonotrode that is mounted on a base plate 10. The rotary sonotrode comprises a rotary body 12 that is connected to a converter 14 that is in turn connected to a rotary coupler 18 via a cylindrical housing 15 and a toothed wheel 16. The rotary body 12, the converter 14, the housing 15, the toothed wheel 16, and a rotary disk 17 of the rotary coupler 18 thus form a unit that can be rotated about its longitudinal axis L. A rotation of this unit can take place by a drive, not shown, whose torque is transmitted to the toothed wheel 16 via a toothed belt or the like.

FIG. 2 shows an enlarged sectional representation of the rotary body 12 of FIG. 1. In a manner known per se, said rotary body 12 comprises a disk-shaped element whose outer peripheral surface forms a working surface 22 of the rotary sonotrode. Shaft sections 24 and 26 extend along the longitudinal axis L at both sides of the disk-shaped element 20, wherein the shaft section 26 merges into an elongated shaft section 28 that serves for connection to the converter 14.

FIG. 1 illustrates that, in the embodiment shown, the rotary sonotrode is supported along the longitudinal axis L at a total of three locations A, B, and C. More specifically, a respective rotary bearing 30 and 32 are provided at both sides of the disk-shaped element 20 of the rotary body 12, wherein the two rotary bearings 30 and 32 adjoin the disk-shaped element 20 of the rotary body 12 without an intermediate space in the side view. A third rotary bearing 34 is arranged in a region that extends in the axial direction from the rotary coupler 18 up to the converter 14. Here, the outer ring of the rotary bearings 30, 32, 34 is in each case fastened in a stationary manner on the base plate 10. In the embodiment shown, the bearing 34 is arranged directly next to the toothed wheel 16 that connects the converter 14 to the rotary disk 17 of the rotary coupler 18. However, the rotary bearing 34 could also be offset slightly more toward the rotary body 12 in the axial direction. However, since only the rotary bearing 34, but not the two rotary bearings 30 and 32, also effects an axial support for the rotary sonotrode, the positioning, present in the embodiments shown, of the rotary bearing 34 close to the rotary coupler 18 is particularly advantageous since it is hereby ensured that an air gap between the rotary disk 17 and a rotationally fixed disk of the rotary coupler 18 can be kept constant and in an order of about 0.1 mm.

The transmission of the electrical energy required for the operation of the converter takes place via a radio frequency connector 40 that is in turn electrically connected to the stationary disk of the rotary coupler 18. Within the rotary coupler 18, the electrical energy is transmitted contactlessly (e.g. inductively) to the rotary disk 17 and is fed to the converter 14.

To minimize a transmission of the ultrasonic vibrations generated by the converter 14 to the rotary bearings 30 and 32, a respective vibration damper 42 and 44, whose embodiments are shown in more detail in FIGS. 2 to 4, is provided between each rotary bearing 30, 32 and the rotary body 12.

As first illustrated by FIG. 2, each vibration damper has an inner ring 50 and an outer ring 52 that are connected to one another in one piece via spokes S. Each vibration damper is manufactured in one piece from metal and is applied by means of press fitting (e.g. by thermal shrinking) to a shaft section 24 and 26 of the rotary body 12. As FIG. 2 illustrates in this respect, the disk-shaped element 20 and the two vibration dampers 42 and 44 overlap in section since the disk-shaped element of the rotary body 12 has a respective recess 46 and 48 at its two side surfaces. The rotary body 12 can hereby be supported in close proximity to the working surface 22.

FIG. 3 and FIG. 4 show two different embodiments of vibration dampers. In the embodiment of FIG. 3, the spokes S extend spirally from the inner ring 50 to the outer ring 52. In the embodiment of a vibration damper shown in FIG. 4, the spokes S extend in the radial direction from the inner ring 50 to the outer ring 52. In this embodiment, each spoke S also tapers in the radial direction from the inner ring 50 to the outer ring 52 so that each spoke appears trapezoidal in a plan view and an approximately triangular clearance is formed between two adjacent spokes. In both embodiments, the spokes S each form an outer side of the vibration damper, i.e. the spokes are not completely but only partly located within the outer ring 52.

Furthermore, FIGS. 2 to 4 illustrate that, in the embodiments shown, the inner ring 50 is provided with a circular groove 54 that is formed by an incision.

The spokes S can naturally also have other designs. Thus, the spokes can, for example, be of a wave-like, zigzag, or V-shaped design and can also extend further into the interior of the outer ring 52.

Finally, in the embodiments shown, the vibration damper in each case has a peripheral annular web 56 that serves as an abutment on an insertion of the vibration damper into the rotary bearing.

1-10. (canceled)

11. A rotary sonotrode comprising:
a rotary body that has a working surface and that is rotatably supported about its longitudinal axis in at least one rotary bearing,
a vibration damper provided between the rotary bearing and the rotary body and the vibration damper having an inner ring and an outer ring, the inner ring and the outer ring being connected to one another in one piece via spokes,
wherein the inner ring is connected to the rotary body in a rotationally fixed manner but not in one piece, and
wherein the outer ring is rotatably received in the rotary bearing.

12. The rotary sonotrode in accordance with claim 11,
wherein the spokes extend spirally from the inner ring to the outer ring.

13. The rotary sonotrode in accordance with claim 11,
wherein the spokes extend in a radial direction from the inner ring to the outer ring.

14. The rotary sonotrode in accordance with claim 11,
wherein the spokes taper in the radial direction from the inner ring to the outer ring.

15. The rotary sonotrode in accordance with claim 11,
wherein the spokes widen in the radial direction from the inner ring to the outer ring.

16. The rotary sonotrode in accordance with claim 11,
wherein the spokes form an outer side of the vibration damper.

17. The rotary sonotrode in accordance with claim 11,
wherein the inner ring is provided with a circular groove.

18. The rotary sonotrode in accordance with claim 11,
wherein the vibration damper is formed in one piece.

19. The rotary sonotrode in accordance with claim 11,
further comprising a converter that is electrically and mechanically connected to a contactless rotary coupler, and wherein the rotary sonotrode has a single axial bearing that is arranged in a region that extends in an axial direction from the rotary coupler up to the converter.

20. A vibration damper for a rotary sonotrode, the vibration damper having an inner ring and an outer ring, wherein the inner ring and the outer ring are connected to one another in one piece via spokes.

21. The vibration damper in accordance with claim 20, wherein the rotary sonotrode comprises a rotary body that has a working surface and that is rotatably supported about its longitudinal axis in at least one rotary bearing,
with the vibration damper being providable between the rotary bearing and the rotary body, wherein the inner ring is connected to the rotary body in a rotationally fixed manner but not in one piece, and wherein the outer ring is rotatably received in the rotary bearing.
